(19) United States
(12) Patent Application Publication
(10) Pub. No.: US 2009/0313111 A1
(43) Pub. Date: Dec. 17, 2009

(54) TRACK IMPRESSION OF ADVERTISEMENT UPON MEMORY

(75) Inventors: William J. Westerinen, Sammamish, WA (US); James R. Hamilton, Bellevue, WA (US); Ruston Panabaker, Redmond, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/140,849

(22) Filed: Jun. 17, 2008

(51) Int. Cl. G06Q 30/00

(52) U.S. Cl. 705/14.35

(57) ABSTRACT

Oftentimes users can be exposed to media content such as advertisements while in a non-connective state. Advertisement providers can desire to obtain information related to the exposure and users can be rewarded for the exposure. Therefore, a record can be retained related to advertisement exposure and the record can be transmitted when it is determined that the user is in a connective state. Since personal information can be held upon the record and there can be motivation to alter the record, the record can be stored in hardware, such as a microcontroller of a flash memory device, prior to transmission.

### TECHNICAL FIELD

The subject specification relates generally to retaining information and in particular to tracking advertisement information upon memory.

### BACKGROUND

Many individuals use personal electronic devices as part of their daily life. For example, an individual can use a cellular telephone to engage in voice communication, transfer photographs, read electronic mail messages, and the like. The devices can be specifically tailored to a function (e.g., a digital music player) or be more general in use (e.g., a notebook computer that can be used for word processing, sharing electronic mail, tracking accounting records, etc.). Moreover, these devices can be relatively small and lightweight, thus allowing the individual to use the device in a variety of scenarios.

Different personal electronic devices can employ a variety memory types to achieve desirable functionality. In an illustrative instance, information that is used for temporary purposes can be retained in volatile memory, such that when constant power is not supplied to the memory the information can be lost. Other features can be implemented upon these devices, including a display screen to present information to a user as well as a physical lock that can assist in securing the device through use of a key that engages the lock.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

An individual can use a personal electronic device to traverse a data network (e.g., Internet), view video content such as movies, etc. As the user engages upon the devices, he can be exposed to advertising, such as movie previews. It can be beneficial for an advertiser to learn of the exposure and a user can be rewarded for being exposed. However, there can be instances when the user and/or the personal electronic device are not in a connective state such that exposure information cannot be readily communicated.

Therefore, a record can be retained related to the exposure and the record can be transferred when a connective state is reached. Analysis can occur to determine that a user is exposed to an advertisement and a record can be retained related to the exposure. Different configurations can be practiced; for example, the record can be automatically retained and then transferred once a connective state is identified or a record can be made when in a disconnected state and streaming of information can occur when exposure is timed with a connective state. To prevent tampering with the record, the record can be held on hardware—including a flash memory device with a microcontroller. Conventionally in industry research, records are generated in software and stored on conventional storage or relayed over a network. However, this poses a risk of easy modification or false representation of the transaction and there has been a long felt need to increase security of exposure records. The disclosed innovation takes the research in a new direction by generating and storing the record in hardware, thus answering the long felt need by adding more security to retaining the exposure record.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for retaining a record related to media content exposure in accordance with an aspect of the subject specification.

FIG. 2 illustrates a representative system for retaining a record related to media content exposure with a detailed conformation component in accordance with an aspect of the subject specification.

FIG. 3 illustrates a representative system for retaining a record related to media content exposure with a detailed preservation component in accordance with an aspect of the subject specification.

FIG. 4 illustrates a representative system for retaining a record related to media content exposure with a detailed security component and transaction component in accordance with an aspect of the subject specification.

FIG. 5 illustrates a representative system for retaining a record related to media content exposure and performance of reward action related to the exposure in accordance with an aspect of the subject specification.

FIG. 6 illustrates a representative system for processing a record that includes media content exposure information in accordance with an aspect of the subject specification.

FIG. 7 illustrates a representative methodology for transmitting a record that relates to media content exposure in accordance with an aspect of the subject specification.

FIG. 8 illustrates a representative methodology for processing a media content exposure record in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through use of artificial intelligence techniques.

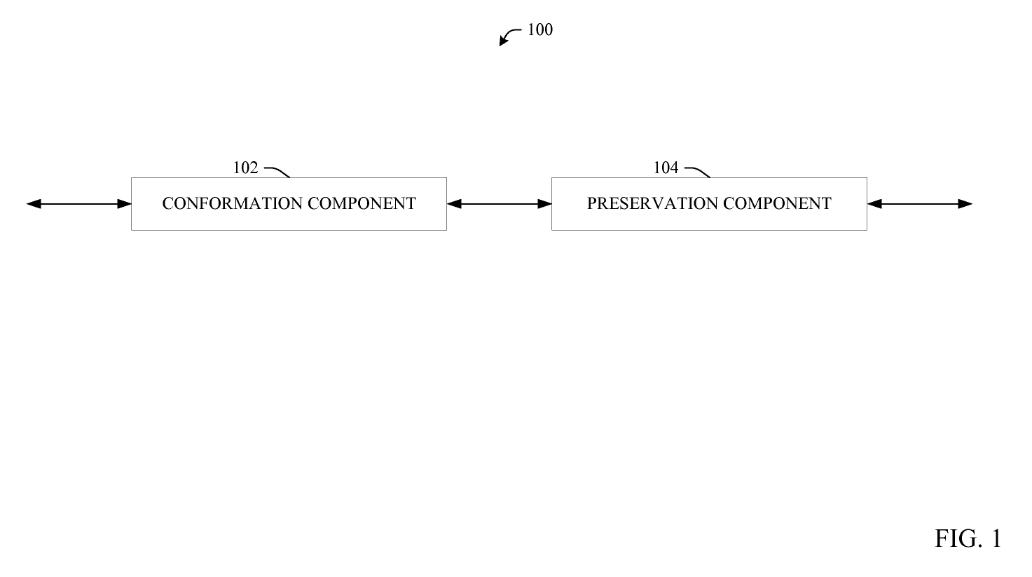

Now referring to FIG. 1, an example system 100 is disclosed for retaining a record related to user exposure to media content, such as an advertisement. Commonly, a user can be exposed to an advertisement, specifically though use of a personal electronic device. For example, the user can be on a page of a data network (e.g., Internet) where a page has several billboards (e.g., a small copy of a trademark on a boarder of the page). As the user spends time viewing the page, she can become exposed to the advertisement. Information related to user exposure—specific to the user as well as more broad observations—can be beneficial to an advertiser. Thus, conventionally a record of exposure can be transmitted to the advertiser. An example record can include an amount of time the user spent exposed to the advertisement, interaction the user has with the advertisement (e.g., engaging a billboard to open another page related to the advertisement), etc.

However, there can be instances where a user is in a non-connective state (e.g., no conductivity, relatively low conductivity, temporary conductivity, etc.) and thus exposure information cannot and/or should not be transmitted. Therefore, a record related to the exposure can be retained in storage and once a connective state is reached, the record can be transferred to an appropriate entity. In an illustrative example, a user can be travelling on an airplane while watching a movie. Prior to watching the movie, the user can be exposed to several previews; however, it is possible that the airplane can restrict communication and thus the exposure cannot be transferred.

The system 100 can employ a conformation component 102 that verifies an exposure of a user to media content (e.g., visual, audio, etc.), where the media content can be an advertisement. The conformation component 102 can monitor both the user (e.g., where a user focuses, attention of the user derived from monitored heart rate, etc.) and the advertisement (e.g., size). A check can be performed to determine if there is a related connective state and if a result of the check is negative then a preservation component 104 can retain a record of the user exposure upon hardware. According to one embodiment, this can occur when the hardware is in a disconnected state

Content of the record can be considered important information and thus can have an associated risk of tampering. For example, a user can be provided a reward for being exposed to an advertisement, such as a coupon. There can be a risk that the user alters the record to represent that there was more exposure then what actually takes place. Therefore, the record can be retained in secure hardware as opposed to software; in one example, the hardware can be a microcontroller of a flash memory device. Moreover, the record can include an indicator that the user is exposed to the media content and metadata related to the exposure, the metadata includes a time of the exposure, probability of the record being accurate, user dedication during the exposure, or a combination thereof. Once a connective state is reached, then the record can be transferred to an appropriate location—transferring can occur automatically, upon request and/or conformation of a user and/or collecting entity, and the like.

Additionally, the system 100 can be used to identify and/or verify identity (e.g., of a user, of a device of the user, etc.). One implementation can use certificates (e.g., containing public keys) associated with an advertisement and/or a user's device sent to a flash device when the advertisement is consumed. These certificates and a record of the advertisement being consumed could be encrypted in the flash device using a public key certificate previously populated by an advertising collection network.

For example, a first party ‘A’ (e.g., an advertiser) can use a private key to encrypt (e.g., sign) an agreement to pay a certain amount of money for viewing an advertisement. Using a public key, other parties (e.g., party ‘B’) can decrypt (e.g., verify) the agreement, where validity can depend upon private key security. In another embodiment, combining keys (e.g., one private and one public) can allow for a shared secret. The shared secret can be used as a key for a symmetric cipher. A flash device could use it's own private key to encrypt information so that there could be secure transmission at a later time to a trusted agent which could verify the identity of the sender, decrypt records using its own private key and contact other Certificate Authorities necessary to validate the identity or validity of the user.

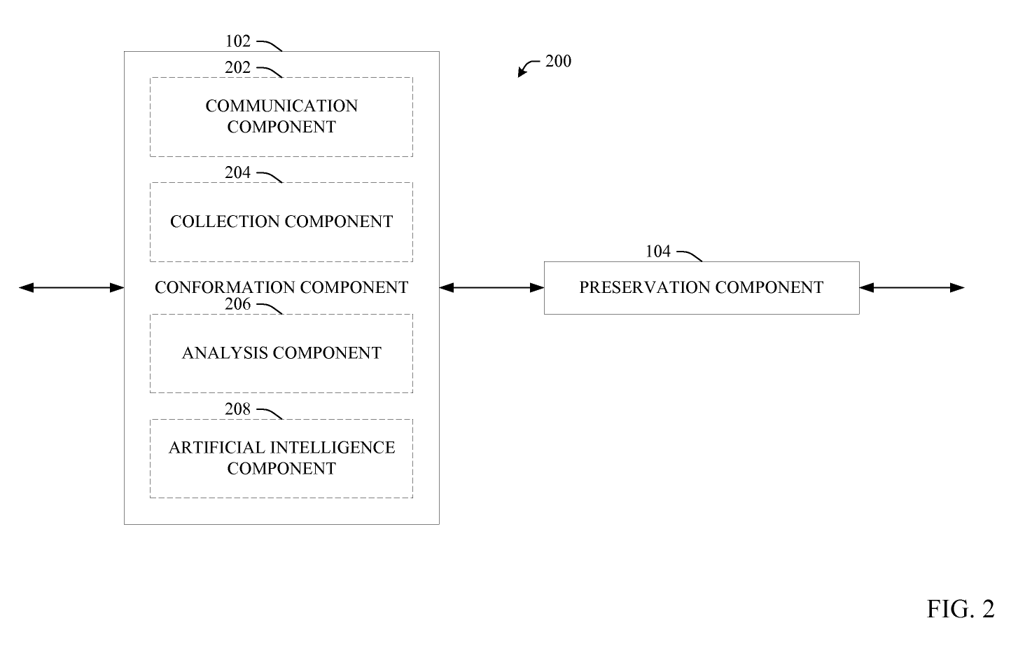

Now referring to FIG. 2, an example system 200 is disclosed for retaining a record related to media content exposure with a detailed conformation component 102. The conformation component 102 can verify an exposure of a user to media content, where verification can include determining existence of exposure, making calculations related to the exposure, and the like. To facilitate operation, the conformation component 102 can use a communication component 202 that can use standard, proprietary protocols, communication channels, etc. as well as engage with other devices to transfer information, such as obtaining a command, sending a request for metadata, receiving metadata from an auxiliary source, and the like. In an illustrative example, the communication component 202 can engage with a timer to assist in determining how long an exposure lasts. Operation can take place wirelessly, in a hard-wired manner, employment of security technology (e.g., encryption), etc. Additionally, metadata transfer can be active (e.g., query/response) or passive (e.g., monitoring of public communication signals). Moreover, the communication component 202 can use various protective features, such as performing a virus scan on collected metadata and blocking metadata that is positive for a virus.

A collection component 204 can obtain data related to the exposure as well as a connective state related to a user. For instance, the collection component 204 can monitor a heart of the user during playing of a video advertisement. An analysis component 206 can evaluate the obtained data, perform calculations related to the data, make estimations related to the data, and the like. Using the aforementioned instance, an inference can be drawn such that the higher heart rate is indicative that the user has high exposure to the advertisement (e.g., excitement from an advertisement designed to excite a user, such as a preview for an action film)—thus, the user can receive a higher monetary reward.

An artificial intelligence component 208 can make at least one inference or at least one determination in relation to exposure verification and/or record retention, as well as other aspects disclosed herein. The artificial intelligence component 208 can employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. In addition, the artificial intelligence component 208 can also include methods for capture of logical relationships such as theorem provers or more heuristic rule-based expert systems. The artificial intelligence component 208 can be represented as an externally pluggable component, in some cases designed by a disparate (third) party. The artificial intelligence component 208 can be updated based on learning techniques as well as a list of descriptors for the memory device types and capabilities themselves. A preservation component 104 can retain a record of the user exposure upon hardware, typically when the hardware is in a disconnected state.

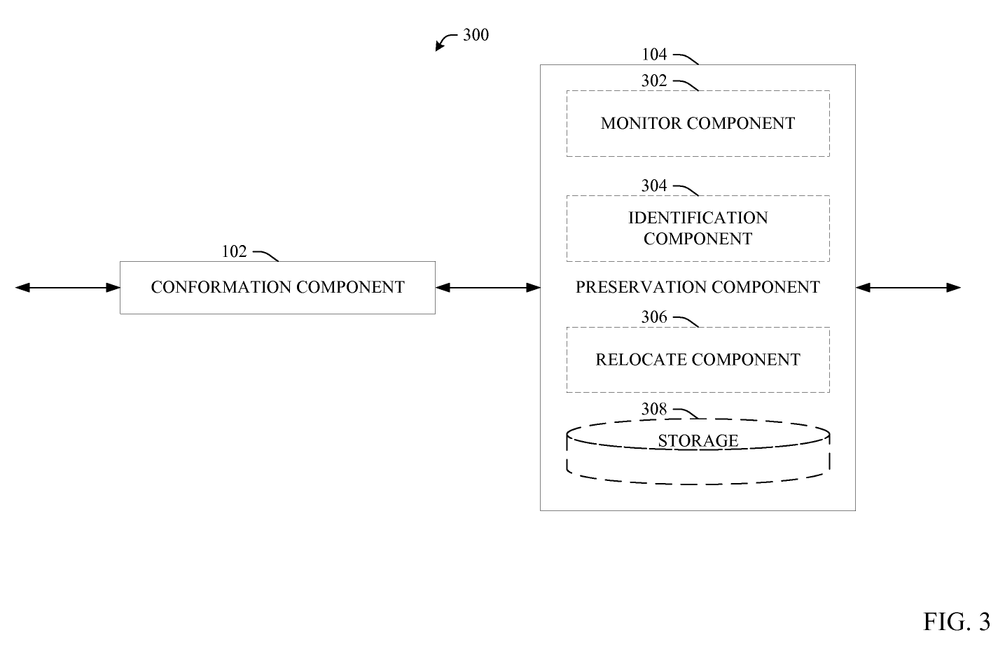

Now referring to FIG. 3, an example system 300 is disclosed for retaining a record related to media content exposure with a detailed preservation component 104. A conformation component 102 can verify that there is an exposure of a user to media content. With a verified exposure, a preservation component 104 can retain a record of the user exposure upon hardware commonly when the hardware is in a disconnected state.

A monitor component 302 can continuously operate to evaluate a connective state related to the user (e.g., determine when connectivity is achieved). A connective state can be a state capable of reasonable assurance that a communication can be successful as well as a connective/non-connective comparison. For instance, during poor weather a user can experience a level of connectivity; however, due to interference the conductivity can be poor and an inference can be made that communication of a record should not occur.

An identification component 304 can determine when the hardware achieves a connected state, such as a state where communication of the record should occur. A relocate component 306 can transfer the retained record to an auxiliary entity upon the determination that a connected state is achieved. Commonly, wireless transmission is implemented and the relocate component 306 can request that a conformation response be sent. If a conformation is not collected, then retransmission can occur (e.g., until the connective state is lost, after a set number of attempts, and the like).

Different pieces of information, such as collected metadata, component operating instructions (e.g., communication component 202 of FIG. 2), components themselves, etc. can be held on storage 308. Storage 308 can arrange in a number of different configurations, including as random access memory, battery-backed memory, hard disk, magnetic tape, flash, etc. Various features can be implemented upon storage 308, such as compression and automatic back up (e.g., use of a Redundant Array of Independent Drives configuration). In addition, storage 308 can operate as memory that can be operatively coupled to a processor (not shown). Storage 308 can be implemented as a microcontroller of a flash memory device and/or the flash memory device.

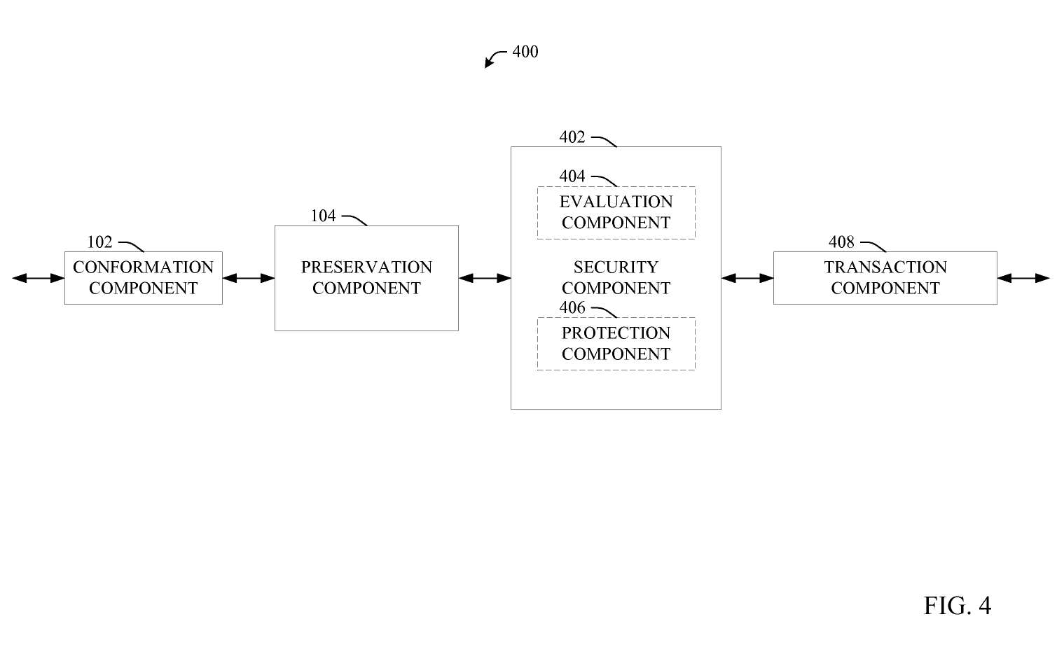

Now referring to FIG. 4, an example system 400 is disclosed for protecting media content exposure information and rewarding the user for the exposure. A conformation component 102 can verify that there is an exposure of a user to media content and collect metadata related to the exposure, such as length of exposure, attentiveness level, and the like. A preservation component 104 can retain a record of the user exposure upon hardware commonly when the hardware is in a disconnected state and the record can be transferred upon reaching a connective state. According to an alternative embodiment, the record can be retained, a determination can be made on a connective state; if there is a connective state the record can be transferred and if not then the record can be retained until a connective state is gained, a set amount of time occurs, and the like.

Information of the record and the record itself can be prone to several security risks and a security component 402 can be used to assist in alleviating the risks. It is possible for a user to be provided a reward for being exposed to media content and thus there can be motivation for there to be alteration to the record. The security component 402 can perform actions to deter and/or prevent record alteration. According to one embodiment, different storage locations can be available for record retention. The security component can determine a risk associated with record alteration and intelligently choose a memory location as a function of security.

In addition, the record itself can include sensitive information that a user or another party can desire to keep relatively secret. For instance, a user can visit job searching pages and be exposed to job search related advertisements; if the user has a job, then she can desire that no one but a rewarding agency learn about the pages she visits. An evaluation component 404 can be used by the security component to intelligently identify sensitive information of the retained record, which can be done though historical learning, artificial intelligence techniques, specific requests by an entity, and the like. A protection component can encrypt the identified sensitive information prior to transfer and the relocate component 306 of FIG. 3 can transfer the record. Various other protective measures can also be use; for example, the evaluation component 404 can identify evaluate communication channels and the protection component 406 can choose a channel that has desirable security characteristics, the relocate component 306 can transfer the record along the chosen channel.

A transaction component 408 can be used to facilitate rewarding a user for exposure to media content. Thus, the transaction component 408 can perform a reward operation based upon achievement of a standard. An auxiliary entity can evaluate the record and determine that the user should be rewarded. A message can transfer to the transaction component 408 and the transaction component 408 can respond to the message signifying a type of reward that a user can desire (e.g., the reward can be determined through artificial intelligence techniques). In another example, the auxiliary entity can notify the transaction component 408 that a credit is earned and the transaction component 408 can add the credit to a bank account. If a reward is a coupon, then transaction component 408 can engage with a user on how the coupon is used and/or the transaction component 408 can print the coupon.

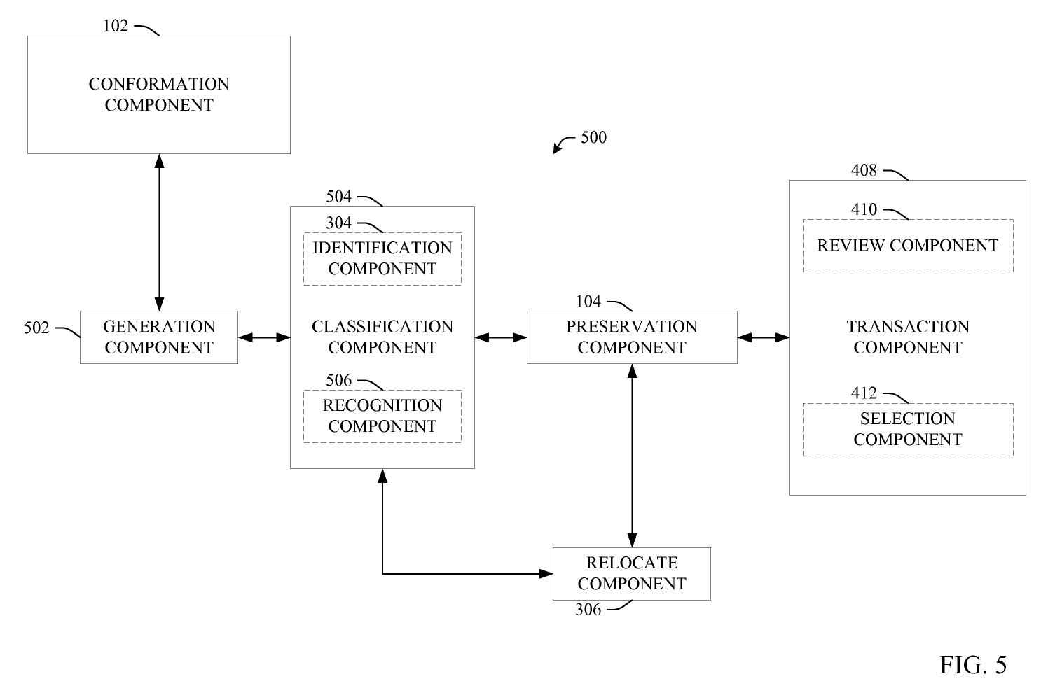

Now referring to FIG. 5, an example system 500 is disclosed for facilitating record keeping related to advertisement exposure, commonly for when a user is in a non-connective state. A conformation component 102 can observe a user and made inferences and/or determinations on exposure of the user to an advertisement. The conformation component 102 can operate as means for observing an exposure of a user to an advertisement.

A generation component 502 can create a record based upon an observation made by the conformation component 102. Artificial intelligence can be used to decipher observations made by the conformation component 102 can what information should be included upon a record. The generation component 502 can implement as means for creating a record that includes metadata that relates to the exposure of the user to the advertisement, the record is created as a function of the observed exposure to a user.

A classification component 504 can determine a connective state related to the user. An identification component 304 can check for the connective state; if there is a connective state, then a relocate component 306 can immediately transfer the record. However, if there is not a connective state, then a recognition component 506 can continuously check to determine if a connective state is reached. In addition, a preservation component 104 can retained the record created by the generation component 502 upon a determination that there is not a connective state. The identification component 304 can function as means for identifying a connective state related to the user while the preservation component 104 can operate as means for retaining the created record upon hardware when the connective state related to the user is negative. According to one embodiment, the hardware is a microcontroller of a flash memory device. Moreover, the recognition component 506 can implement as means for recognizing when the connective state related to the user becomes positive.

Upon determining that the connective state is positive (e.g., through the identification component 304 and/or the recognition component 506) a relocate component 306 can transfer the record to an auxiliary entity. The relocate component 306 can function as means for transferring the retained record upon determining that the connective state related to the user is positive. According to one embodiment, means transferring the retained record upon determining that the connective state related to the user is positive functions upon identifying a positive connective state related to the user (e.g., after an initial check a positive determination is made) or upon recognizing that the connective state becomes positive (e.g., while an initial check results in a negative result, through observation it is determined that connective state changes). The relocate component 306 can be a transmitter (e.g., a transmission device that includes an antenna); however, the relocate component 306 can also function to send a message to a transmitter that transmission of the record should occur.

A user can be rewarded for being exposed to the advertisement and a transaction component 408 can function to facilitate rewarding the user. The transaction component 408 can operate as means for compensating the user for transferring the retained record with a reward. When a record is transferred, a review component 410 can evaluate the reward to determine a likelihood that a reward can be provided for the record. For instance, the review component 410 can check publically available reward offers (e.g., through use of the communication component 202 of FIG. 2) and determine if the record contains information that match reward requirements. The review component 410 can operate as means for evaluating the transferred retained record. A type of reward can be chosen by a selection component 412 that can function as means for selecting the reward based upon a result produced by the means for evaluating the transferred retained record. In one implementation, the transaction component 408 can function prior to sending a record and associate reward metadata with the record.

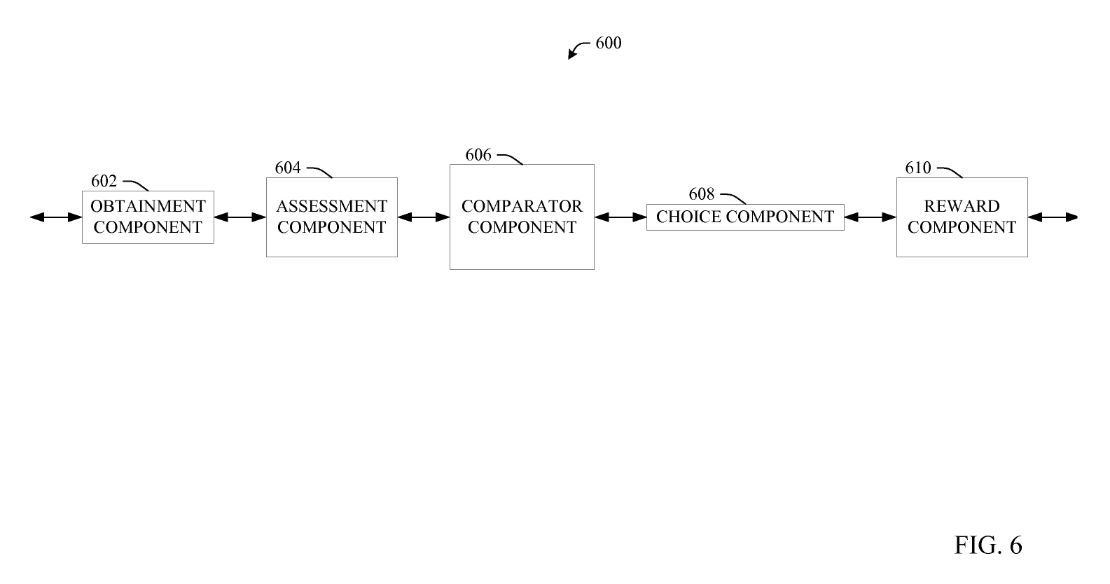

Now referring to FIG. 6, an example system 600 is disclosed for processing a record. According to one embodiment, the system 600 can operate upon an auxiliary entity that is communicated the record from the relocate component 306 of FIG. 3. An obtainment component 602 can collect the record; the record can be directed to the system 600 or the record can be broadly distributed, where the obtainment component 602 extracts the record. Moreover, the obtainment component 602 can make a request to a supplying unit (e.g., the system 100 of FIG. 1) and extract the record from the supplying unit.

An assessment component 604 can evaluate the record collected by the obtainment component 604 and produce an evaluation result. The evaluation result can include user identification, metadata related to the exposure, and the like. A comparator component 606 can determine if the record meets criteria set forth for earning a reward (e.g., by comparing the evaluation result and/or collected record against a reward standard).

The system 600 can use a choice component 608 to select a reward for a user exposed to the advertisement (e.g., selecting a type of reward, an amount of a reward, and the like). According to one embodiment, selection occurs based upon a request of the user, availability of a reward, random selection (e.g., random drawing for a reward), or a combination thereof. A reward component 610 can provide the selected reward to a user, such as crediting a bank account of a user.

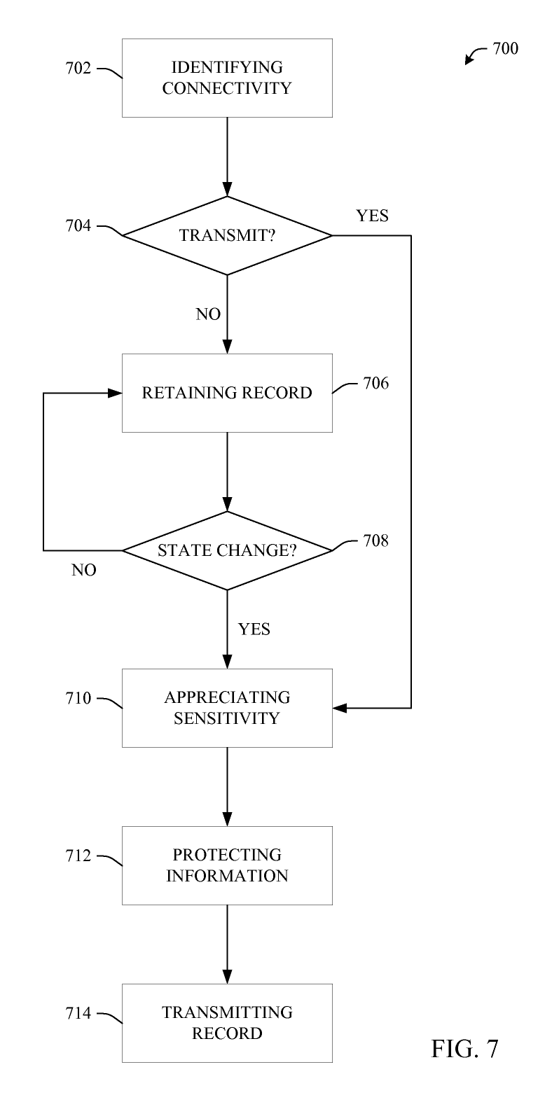

Now referring to FIG. 7, an example methodology 700 is disclosed for using a record with regard to exposure of a user to an advertisement, commonly when the exposure and/or a time of communication fall within a state of disconnection. A level of connectivity can be identified at event 702, such as sending test communication and determining if there is success. Event 702 allows for identifying a connective state related to a user.

A check 704 can occur to determine if a transmission of a record should occur. The determination can conclude if a record related to user exposure to an advertisement should be transmitted as a function of the identified connective state (e.g., there is no connectivity, connectivity is poor, there is heavy traffic, etc.). If it is determined that the transmissions should not occur, then at act 706 there can be retaining the record, commonly the record is retained in a secure manner, such as masking the record. Another check 708 can occur to monitor connectivity and determine if there has been a change (e.g., any change, a change substantial enough to warrant communication of the record, and the like).

If there is a state change substantial enough to warrant communication (e.g., after the check 704, after the check 708, etc.), then there can be appreciating sensitive information related to the record at event 710. Appreciation can include identifying information likely to be sensitive. At action 712, there can be protecting the sensitive information, such as encrypting the information. According to one embodiment, transmitting the record occurs with the record having protected sensitive information.

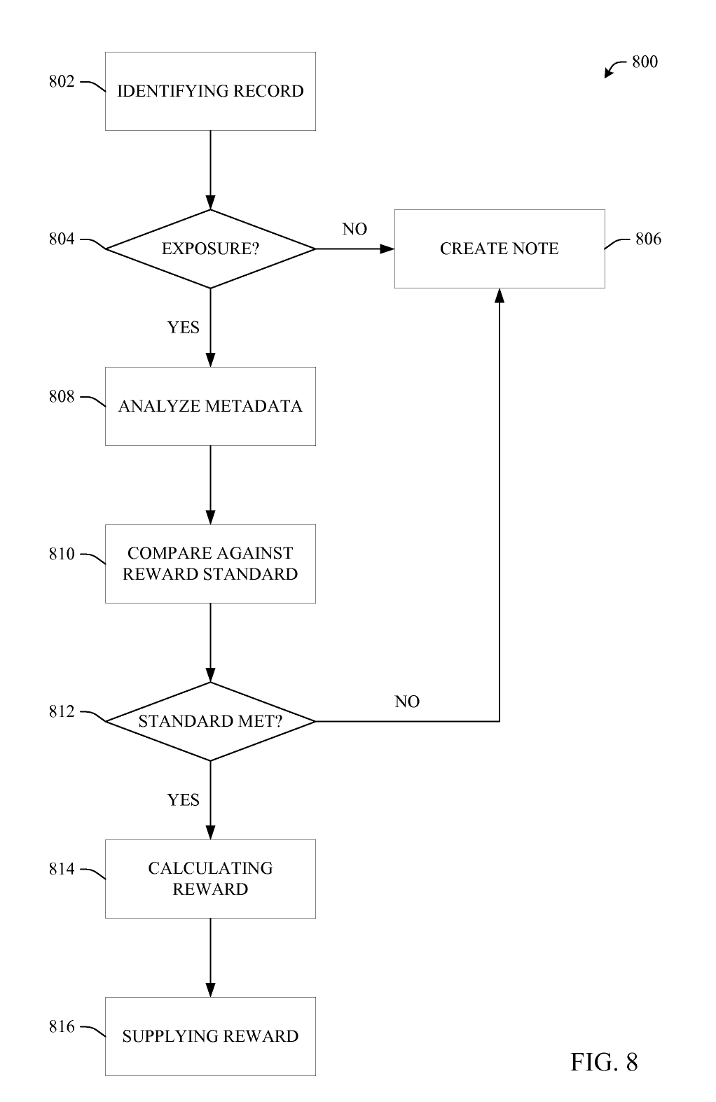

Now referring to FIG. 8, an example methodology 800 is disclosed for processing a record (e.g., a record transmitted at action 712 of FIG. 7). A record can be identified at block 802 and a check 804 can be used to determine if there is exposure of a user to an advertisement. If there has been no exposure, then a record can be created at action 806 (e.g., for statistical purposes, to use in a profile for a user, and the like). If there has been exposure then metadata related to the record can be extracted, aggregated, analyzed, and the like at act 808.

The metadata and/or a result of act 808 can be compared against a standard to earn a reward at action 810. A check 812 can occur to determine if a result of the comparison meets the standard. If the standard is not met, then the methodology 800 can return to act 806; however, if the standard is met, then a reward can be calculated at event 814 and supplied to a user at act 816.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

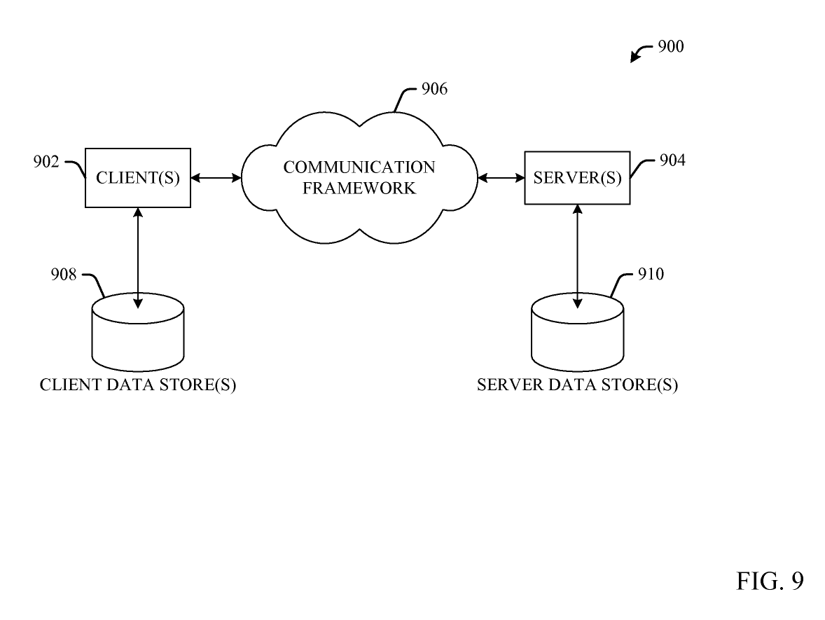

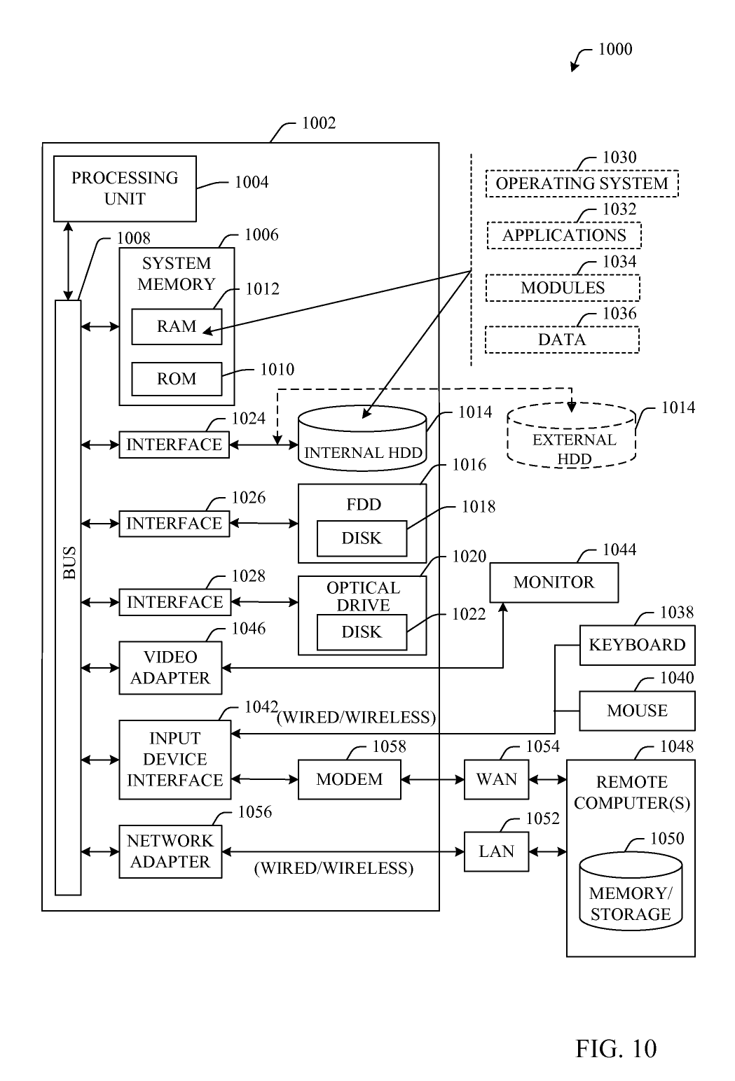

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising
a conformation component that verifies an exposure of a user to media content; and
a preservation component that retains a record of the user exposure upon hardware when the hardware is in a disconnected state.

2. The system of claim 1, further comprising an identification component that determines when the hardware achieves a connected state.

3. The system of claim 2, further comprising a relocate component that transfers the retained record to an auxiliary entity upon the determination that a connected state is achieved.

4. The system of claim 3, further comprising:
an evaluation component that intelligently identifies sensitive information of the retained record; and
a protection component that encrypts the identified sensitive information prior to transfer.

5. The system of claim 3, further comprising a transaction component that performs a reward operation based upon achievement of a standard.

6. The system of claim 5, the standard is successful transmission of the retained record, successful obtainment of the retained record by the auxiliary entity, identification of a result appreciated by the auxiliary entity though observation of the retained record, or a combination thereof.

7. The system of claim 1, the hardware is a microcontroller of a flash memory device.

8. The system of claim 1, the media content is an advertisement.

9. The system of claim 1, the record includes an indicator that the user is exposed to the media content and metadata related to the exposure, the metadata includes a time of the exposure, probability of the record being accurate, user dedication during the exposure, or a combination thereof.

10. A method, comprising:
identifying a connective state related to a user; and
determining if a record related to user exposure to an advertisement should be transmitted as a function of the identified connective state.

11. The method of claim 10, further comprising transmitting the record upon determining that the record should be transmitted.

12. The method of claim 11, further comprising:
appreciating sensitive information related to the record; and
protecting the sensitive information, transmitting the record occurs with the record having protected sensitive information.

13. The method of claim 10, further comprising retaining the record if it is determined that the record should not be transmitted.

14. The method of claim 13, further comprising:
identifying a change in the connective state related to the user, the change is substantial enough alter the determination from should not be transmitted to should be transmitted; and
transmitting the record.

15. The method of claim 10, the record includes an indicator that the user is exposed to the advertisement and metadata related to the exposure, the metadata includes a time of the exposure, probability of the record being accurate, user dedication during the exposure, or a combination thereof.

16. A system for communication advertisement information, comprising
means for observing an exposure of a user to an advertisement;
means for creating a record that includes metadata that relates to the exposure of the user to the advertisement, the record is created as a function of the observed exposure to the user;
means for identifying a connective state related to the user;
means for retaining the created record upon hardware when the connective state related to the user is negative;
means for recognizing when the connective state related to the user becomes positive; and
means for transferring the retained record upon determining that the connective state related to the user is positive.

17. The system of claim 16, further comprising means for compensating the user for transferring the retained record with a reward.

18. The system of claim 17, further comprising:
means for evaluating the transferred retained record; and
means for selecting the reward based upon a result produced by the means for evaluating the transferred retained record.

19. The system of claim 18, means transferring the retained record upon determining that the connective state related to the user is positive functions upon identifying a positive connective state related to the user or upon recognizing that the connective state becomes positive.

20. The system of claim 19, the hardware is a microcontroller of a flash memory device.
